(19) United States
(12) Patent Application Publication
(10) Pub. No.: US 2020/0227762 A1
(43) Pub. Date: Jul. 16, 2020

(54) FUEL CELL SYSTEM AND CONTROL METHOD THEREFOR

(71) Applicant: JIANGSU HORIZON NEW ENERGY TECHNOLOGIES CO., LTD., Suzhou, Jiangsu (CN)

(72) Inventors: Ke JIN, Suzhou, Jiangsu (CN); Arthur KOSCHANY, Suzhou, Jiangsu (CN); Yong LU, Suzhou, Jiangsu (CN); Zhijun GU, Suzhou, Jiangsu (CN)

(21) Appl. No.: 16/640,032

(22) PCT Filed: Aug. 15, 2017
(86) PCT No.: PCT/CN2017/097440

§ 371 Date: Feb. 18, 2020

(51) Int. Cl. H01M 8/04858; H01M 8/04223

(52) U.S. Cl. CPC H01M 8/04902; H01M 8/04873; H01M 8/04246

(57) ABSTRACT

A fuel cell system comprises a fuel cell, a switch control module and at least two switch modules; the switch modules each is coupled to a positive electrode and a negative electrode of the fuel cell, and comprises switch units; the switch units each comprises a switch; the switch comprises a control terminal, a current input terminal and a current output terminal; in at least one of the at least two switch modules, the switch unit further comprises a voltage division structure; the voltage division structure is coupled in series between the current input terminal and the positive electrode of the fuel cell, or, the voltage division structure is coupled in series between the current output terminal and the negative electrode of the fuel cell; the switch control module is respectively coupled to the control terminals of the switches of the at least two switch modules to respectively control on-off of the switches.

### TECHNICAL FIELD

The present invention relates to the field of electronic circuit, and particularly relates to a fuel cell system and a control method therefor.

### BACKGROUND OF THE INVENTION

Fuel cell can convert hydrogen and oxygen (usually oxygen in the air) directly into electrical energy with high efficiency, and by-product of the reaction is pure water. Therefore, it has advantages such as saving energy and being environmentally friendly.

In order to improve output performance of the fuel cell, there is a method called “pulsed short-circuiting method” in which the voltage of the fuel cell falls as close as possible to 0 V (volt) in the process of pulse short-circuit. FIG. 1 shows the voltage variation between a cathode and an anode of the fuel cell in the process of pulse short-circuit, wherein a pulse width D is typically less than 200 ms (milliseconds) or even shorter, and a period P of the pulse short-circuit is typically greater than 5 s (seconds) or even longer. Since the duty cycle of the pulse short-circuit is small, the effect on the output power is minimal.

To achieve pulse short-circuit, the corresponding circuit devices are required. Mechanical contactors/relays are not well suited for this function due to problems such as reaction speed, mechanical life, and contact spark life. Therefore, power electronic components such as MOSFET (Metal-Oxide-Semiconductor Field-Effect Transistor), IGBT (Insulated Gate Bipolar Transistor), and the like are generally used. In the process of pulse short-circuit, the MOSFET and the IGBT are turned on, and the cathode and anode of the fuel cell are short-circuited by utilizing the low resistance value when the MOSFET and the IGBT are turned on; when the pulse width is reached, the MOSFET and the IGBT are returned to the off state (or “turned off”). As shown in FIG. 1, the foregoing operations are repeated in accordance with requirements of the pulse width and the period of pulse short-circuit, thereby completing a pulse short-circuit operation on the fuel cell.

When the power and size of the fuel cell are small, it is relatively easy for power electronic components to meet the requirements. However, when the power and size of the fuel cell are large, peak current and single pulse energy released in the process of pulse short-circuit will exceed capability of the power electronic components, and even exceed capability of components parallelly assembled with the power electronic components, causing a rapid damage or a significantly shorten life. Even if the proportionally large-scale power electronic components are used, the problems of damaging power electronic components are still easy to occur. Moreover, even when the power and size of a fuel cell are further increased, it is difficult to find power electronic components with a proportionally increased size. For example, when the rated current of the IGBT reaches 800 A (amperes) or more, the market price rises nonlinearly and remarkably, so that the cost is extremely high.

### SUMMARY OF THE INVENTION

The present invention is to solve the technical problems that switch component of the fuel cell pulse short-circuit control circuit is easily damaged in the process of pulse short-circuit in the prior art, and provides a fuel cell system and a control method therefor.

The present invention solves the above technical problems by providing the following technical solutions:

A fuel cell system, which comprises: a fuel cell, a switch control module and at least two switch modules;

wherein each of the at least two switch modules comprises a switch unit, which comprises a switch, and the switch comprises a control terminal, a current input terminal and a current output terminal;

in the at least two switch modules, the switch unit in at least one switch module further comprises a voltage division structure which is coupled in series between the current input terminal and the cathode of the fuel cell, or is coupled in series between the current output terminal and the anode of the fuel cell;

in the remaining switch modules of the at least two switch modules, the current input terminal is coupled to the cathode of the fuel cell, and the current output terminal is coupled to the anode of the fuel cell;

the switch control module is respectively coupled to the control terminals of the switches of the at least two switch modules for respectively controlling the switches to be turned on or off.

In a preferred embodiment, wherein the switch comprises a MOSFET, and the control terminal is a gate of the MOSFET, the current input terminal is a drain of the MOSFET, and the current output terminal is a source of the MOSFET;

or,

the switch comprises an IGBT, the control terminal is a gate of the IGBT, the current input terminal is a collector of the IGBT, and the current output terminal is an emitter of the IGBT.

In a preferred embodiment, the voltage division structure comprises a resistor.

In a preferred embodiment, in the at least two switch modules, the resistance values of the resistors comprised in the switch units of the different switch modules are different.

In a preferred embodiment, the fuel cell system comprises three switch modules; and two switch modules among the three switch modules comprise the resistor.

In a preferred embodiment, at least one switch module of the at least two switch modules comprises at least two switch units which are coupled in parallel.

In a preferred embodiment, each of the at least two switch units comprises a magnetic ring and a diode, wherein the magnetic ring is sleeved outside a wire of the switch unit; and the wire is a wire between the current input terminal and the cathode of the fuel cell, or the wire is a wire between the current output terminal and the anode of the fuel cell; and the diode is coupled in parallel with the magnetic ring.

In a preferred embodiment, the fuel cell system further comprises emitter followers in the same quantity as that of the switch modules, wherein the switch control module is respectively coupled to the control terminal of the switch in a corresponding switch module via an emitter follower;

or the fuel cell system further comprises isolation amplifiers in the same quantity as that of the switch modules, wherein the switch control module is respectively coupled to the control terminal of the switch in a corresponding switch module via an isolation amplifier;

or the fuel cell system further comprises isolation amplifiers in the same quantity as that of the switch modules and quantity emitter followers in the same quantity as that of the switch modules, wherein the switch control module is respectively coupled to the control terminal of the switch in a corresponding switch module via an isolation amplifier and an emitter follower.

The invention also provides a fuel cell system control method, which is implemented by using the fuel cell system of the invention, wherein the method comprises the following steps:

S1, turning on the switches of the at least two switch modules by the switch control modules sequentially;

S2, turning off the switches of the at least two switch modules by the switch control module after waiting for a first preset time.

In a preferred embodiment, in S1, turning on the switches of the at least two switch modules by the switch control modules sequentially is according to a preset time interval.

In a preferred embodiment, in the fuel cell system control method, step S2 is replaced with step S3:

S3, turning off the switches of the at least two switch modules by the switch control module after waiting for a second preset time.

In a preferred embodiment, the voltage division structure comprises a resistor, and the resistance values of the resistors comprised in the switch units of the different switch modules are different; and

S1 comprises: turning on the switches coupled in series with the resistors by the switch control module according to the resistance values of the resistors in descending order.

In a preferred embodiment, the voltage division structure comprises a resistor, and the resistance values of the resistors comprised in the switch units of the different switch modules are different; and

S3 comprises: turning off the switches coupled in series with the resistors by the switch control module according to the resistance values of the resistors in descending order after waiting for a second preset time.

The positive progresses of the present invention include that the fuel cell system and the control method therefor of the present invention have a low cost, so that the switch units can be protected from damaging in the process of pulse short-circuit and have a longer service life.

### BRIEF DESCRIPTION OF THE DRAWINGS

FIG. 1 is a waveform diagram of a pulse short-circuit of a fuel cell.

FIG. 2 is a circuit diagram of a fuel cell system according to embodiment 1 of the present invention.

FIG. 3 is a flow chart showing a method of controlling a fuel cell system according to embodiment 1 of the present invention.

FIG. 4 is a circuit diagram of a fuel cell system according to embodiment 2 of the present invention.

FIG. 5 is a circuit diagram of a fuel cell system according to embodiment 3 of the present invention.

FIG. 6 is a circuit diagram of a fuel cell system according to embodiment 4 of the present invention.

FIG. 7 is a circuit diagram of a fuel cell system according to embodiment 5 of the present invention.

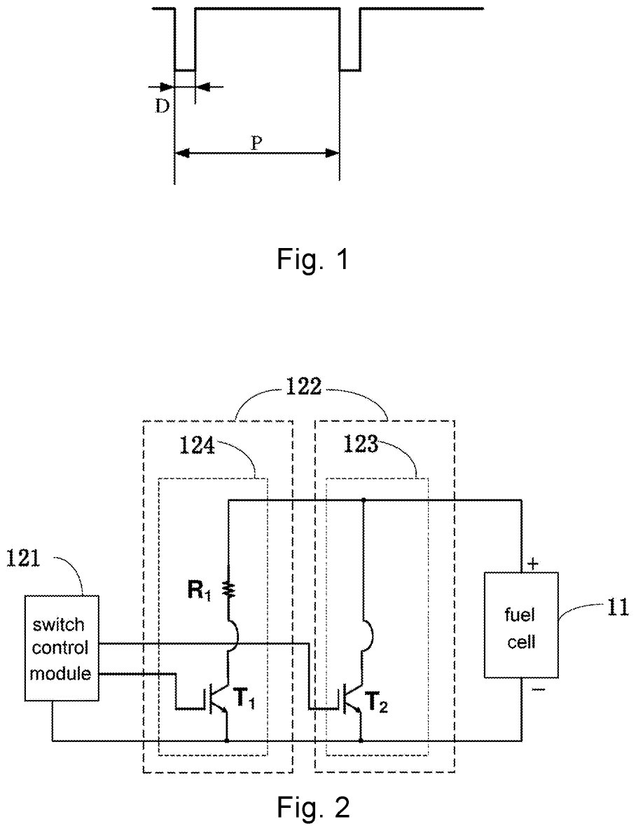

### DETAILED DESCRIPTION OF THE ILLUSTRATED EMBODIMENTS

The present invention is further illustrated by the following embodiments, which are not intended to limit the invention.

### Embodiment 1

A fuel cell system of the present embodiment, as shown in FIG. 2, comprises a fuel cell 11, a switch control module 121 and at least two switch modules 122. Each of the at least two switch modules 122 comprises a switch unit (such as a switch unit 123, a switch unit 124 as shown in FIG. 2). The switch unit comprises a switch which comprises a control terminal, a current input terminal and a current output terminal. The switch unit (such as the switch unit 124 in FIG. 2) in at least one of the at least two switch modules 122 further comprises a voltage division structure which is coupled in series between the current input terminal and the cathode of the fuel cell 11, or is coupled in series between the current output terminal and the anode of the fuel cell 11. The voltage division structure may be a structure capable of realizing a voltage division function, such as a resistor, an elongated wire and an inductor. In the at least two switch modules, in the remaining switch modules (such as the switch module comprising the switch unit 123 as shown in FIG. 2), the current input terminal is coupled to the cathode of the fuel cell, and the current output terminal is coupled to the anode of the fuel cell. The switch control module 121 is respectively coupled to the control terminals of the switches of the at least two switch modules for respectively turning on or off the switches.

As a preferred embodiment, as shown in FIG. 2, the fuel cell system of the present embodiment comprises a fuel cell 11, a switch control module 121 and two switch modules 122. One switch module 122 comprises a switch unit 123, and the switch unit 123 comprises a switch. Specifically, the switch is an IGBT component T₂, and a collector of the T₂ is used as the current input terminal and coupled to the cathode of the fuel cell 11, and an emitter of the T₂ is used as the current output terminal and coupled to the anode of the fuel cell 11. The other switch module 122 comprises a switch unit 124 which comprises a switch, and further comprises a voltage division structure. Specifically, the voltage division structure is a resistor R₁, and the switch is an IGBT component T₁, wherein a collector of T₁ is used as the current input terminal and coupled to one terminal of the resistor R₁, and the other terminal of the resistor R₁ is coupled to the cathode of the fuel cell 11, and an emitter of T₁ is used as the current output terminal and coupled to the anode of the fuel cell 11.

The switch control module 121 is respectively coupled to the gate (control terminal) of T₁ and the gate (control terminal) of T₂, and respectively provides a bias voltage for T₁ and T₂ to turn on or turn off T₁ and T₂.

FIG. 2 shows a preferred embodiment, and the fuel cell system of the present invention is not limited to this circuit configuration. For example, R₁ is coupled in series between the emitter of T₁ and the anode of the fuel cell 11, and similar technical effects can be achieved (however, at this time, the switch control module must comprise an isolation drive function to prevent interference and damage caused by jumping of ground level).

In the present embodiment, the voltage division structure is not limited to the resistor. The elongated electric wire has a certain electric resistance value and may also constitute the voltage division structure in the present invention. Further, components capable of functioning as voltage divider or the like, such as inductors, can be used as the voltage division structure in the present invention. The resistor R₁ can be implemented in various forms, such as a resistor component composed of MOS components.

The switch useful in the present invention can be not only an MGT component but also a MOSFET component, as well as any other components and circuits for turning on and off circuits.

In the fuel cell system of the present embodiment, it is also possible for a technical solution to comprises more than one switch unit 123 (which comprises only the switches but does not comprises a voltage division structure).

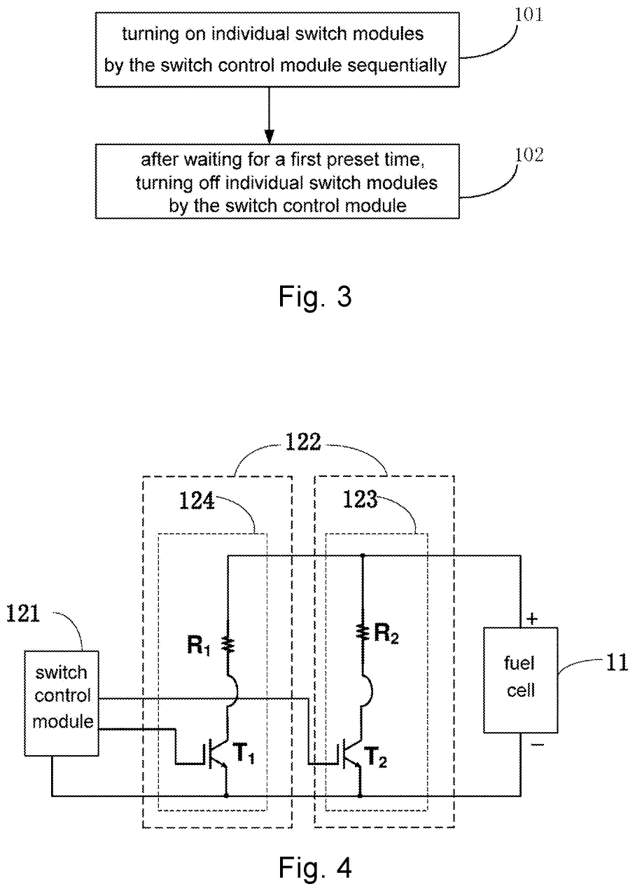

The embodiment further provides a fuel cell system control method. The fuel cell system control method is implemented by using the fuel cell system of the embodiment. As shown in FIG. 3, the method comprises following steps:

S101, turning on the at least two switch modules by the switch control module 121 sequentially;

S102, turning off the at least two switch modules by the switch control module 121 after waiting for a first preset time.

As a preferred embodiment, in S101, the switch control module 121 provides a high-level bias voltage to the gate of the T₁ (in an initial state, the switch control module 121 provides a low-level bias voltage to the gate of T₁, and T₁ is in off state) and controls to turn on T₁. At this time, the cathode and the anode of the fuel cell 11 are short-circuited. In a short time after the short-circuit starts, the released peak current and single pulse energy are large (even more than 2000 A), but due to T₁ and resistor R₁ (for example, 100 mOHM wire-wound cement resistance) are coupled in series, and the conduction internal resistance of T₁ (usually 5 mOHM) is much smaller than the resistance value of the resistor R₁, so the single pulse energy that T₁ is subjected to is much smaller than that in the case where there is no resistor in series (i.e., the technical solution in the prior art), and is also smaller than the safe single pulse energy range that T₁ can withstand. Therefore, T₁ is effectively protected, and will not be damaged in the process of pulse short-circuit, and the service life will not be adversely influenced.

Since there is the resistor R₁ coupled in series, the voltage between the cathode and the anode of the fuel cell 11 is not sufficiently low in the process of pulse short-circuit of S101. In the process of pulse short-circuit, if the voltage between the cathode and anode of the fuel cell 11 is closer to 0 V, then the effect of pulse short-circuit is better; that is, the effect of improving the performance of the fuel cell 11 is better. Therefore, after T₁ is turned on for 5 ms, the switch control module 121 provides a high-level bias voltage to the gate of T₂ (in an initial state, the switch control module 121 provides a low-level bias voltage to the gate of T₂, and T₂ is in off state) and controls to turn on T₂. Since the pulse short-circuit has been going on for a period of time (5 ms), the short-circuit current has decreased, and the danger to the power electronic components (i.e., T₁, T₂) is significantly reduced. Moreover, since T₂ and T₁ are both turned on, and act as shunt resistors, so that the current and single pulse energy endured or subjected by T₂ and T₁ are in a safe range, thereby effectively protecting T₂ and T₁. Meanwhile, since the switch unit 123 only comprises T₂, and there is no voltage division structure (such as a resistor) coupled in series, the conduction internal resistance of T₂ is small, so the short-circuit voltage between the cathode and anode of the fuel cell 11 is pulled down, closing to 0 V, thereby achieving a good pulse short-circuit effect.

Next, in S102, T₂ and T₁ are turned off by the switch control module 121 after waiting for a first preset time. That is, when the pulse width (for example, 50 ms) of the pulse short-circuit is reached, the switch control module 121 controls the gate voltages of T₂ and T₁, and controls to turn off T₂ and T₁ at the same time.

Of course, the following step S103 can also be used to replace S102:

S103, turning off the at least two switch modules by the switch control module 121 after waiting for a second preset time.

Specifically, T₁ is turned off by the switch control module 121 after waiting for the second preset time, and T₂ is turned off by the switch control module 121 after waiting for a third preset time. For example, at the end of 45 ms, the switch control module 121 turns off T₁; at the end of 50 ms, the switch control module 121 turns off T₂. That is, T₂ and T₁ are not necessary to be strictly turned off at the same time. However, the switch unit 123 also functions to further lower the short-circuit voltage of the cathode and anode of the fuel cell 11, so that T₁ is turned off no later than T₂, and a good effect of pulse short-circuit can be achieved.

For a technical solution in which the fuel cell system of the embodiment comprises more than one switch units 123, in the fuel cell system control method of the present embodiment, the switches in the more than one switch units 123 are simultaneously turned on/off; alternatively, the switches in the more than one switch units 123 are sequentially turned on/off; and similar technical effects can be obtained. These should be regarded as equivalent technical features, and all fall within the protection scope of the present invention.

Because the pulse width of pulse short-circuit can be adjusted within a reasonable range, the above 5 ms, 45 ms and 50 ms are all examples. In the fuel cell system control method of the present invention, the first preset time, the second preset time and the third preset time are not limited to the above numerical ranges and can be adjusted as needed. Moreover, the pulse width of each pulse short-circuit is not required to be strictly the same.

### Embodiment 2

The fuel cell system of this embodiment is substantially the same as the fuel cell system of Embodiment 1, except that, as shown in FIG. 4, in the fuel cell system of this embodiment, the switch unit 123 further comprises a resistor R₂ which is coupled in series between the collector of T₂ and the cathode of the fuel cell 11, and the resistance value of R₂ (for example, 50 mOHM) is less than that of R₁ (for example, 100 mOHM).

The present embodiment further provides a fuel cell system control method which is implemented by the fuel cell system of the present embodiment. The steps of the fuel cell system control method are substantially the same as those of the fuel cell system control method of Embodiment 1, except that in S101, the switch control module sequentially turns on the switches coupled in series with the resistors according to the resistance values of the resistors in descending order. The details will not be described again. Since the resistance value of R₂ is smaller than that of R₁, the switch unit 123 is turned on later, and its function is to further lower the short-circuit voltage between the cathode and anode of the fuel cell 11, thereby achieving a good pulse short-circuit effect.

In addition, in the process of turning off T₂ and T₁, T₂ and T₁ can be turned off at the same time; or T₁ is turned off first, and then T₂ is turned off, that is, the switches coupled in series with the resistors are sequentially turned off according to the resistance values of the resistors in descending order. The steps of the two manners of turning off switches have similar technical effects and should be regarded as equivalent, and all fall within the protection scope of the present invention.

### Embodiment 3

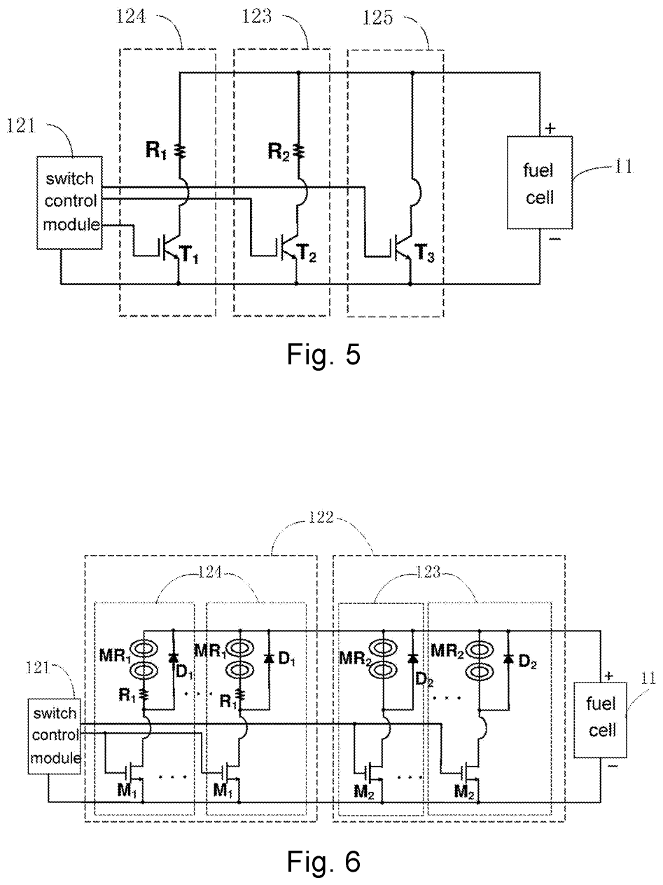

The fuel cell system of the present embodiment is substantially the same as the fuel cell system of the Embodiment 2, except that, as shown in FIG. 5, the fuel cell system of the present embodiment further comprises a third switch module which comprises a switch unit 125, wherein the switch unit 125 comprises a switch T₃, and a gate of T₃ is coupled to the switch control module 121, and a collector of T₃ is coupled to the cathode of the fuel cell 11, and an emitter of T₃ is coupled to the anode of the fuel cell 11.

The fuel cell system of the present embodiment may further comprise more switch modules, wherein the switch units of the more switch modules comprise resistors with resistance values different from those of R₂ and R₁.

The present embodiment further provides a fuel cell system control method which is implemented by the fuel cell system of the present embodiment. The steps of the fuel cell system control method are substantially the same as those of the fuel cell system control method of Embodiment 1.

Specifically, as shown in FIG. 5, in S101, the switch control module 121 controls T₁ to be turned on, and after a preset time interval (for example, 5 ms), T₂ is turned on, and after an other preset time interval (for example, 10 ms), T₃ is turned on (that is, the switch control module sequentially turns on the at least two switch modules according to the preset time intervals). Since the resistance value of R₁ is the largest, it has the best protection effect on the power component (here, T₁) in the process of pulse short-circuit. Therefore, in the fuel cell system control method of the present embodiment, T₁ is turned on first. Next, the T₂ coupled in series with R₂ is turned on. On one hand, the current branch provided by the switch unit 123 which is turned on later is used for shunting, and R₂ is used to protect T₂; on the other hand, since the resistance value of R₂ is smaller than that of R₁, the short-circuit voltage between the cathode and anode of the fuel cell 11 can be further pulled down after T₂ is turned on. Finally, T₃ is turned on, and its function and effect are not redundantly described again.

By using the fuel cell system control method of the present embodiment, the perfect protection of the power components (T₁, T₂, T₃) can be obtained, and the short-circuit voltage between the cathode and anode of the fuel cell 11 gradually approaches 0V, thereby achieving the good effect of pulse short-circuit.

In the fuel cell system control method of the present embodiment, the fuel cell system of the embodiment may further comprise more switch modules, which comprise resistors with resistance values different from those of R₂ and R₁, and the control method of the fuel cell system will not be redundantly described again.

### Embodiment 4

The difference between the fuel cell system of the present embodiment and the fuel cell system of Embodiment 1 is that the at least one of the at least two switch modules in the fuel cell system of the present embodiment comprises at least two switch units, wherein the at least two switch units are coupled in parallel.

Specifically, as shown in FIG. 6, the fuel cell system of the present embodiment comprises two switch modules 122, wherein one of the two switch modules 122 comprises a parallel structure composed of P switch units 123. Each of the P switch units 123 comprises a MOSFET component M₂ used as a switch, wherein a drain of each M₂ is coupled to the cathode of the fuel cell 11, a source of each M₂ is coupled to the anode of the fuel cell 11, and the switch control module 121 is coupled to gate (control terminals) of each M₂, thereby providing a bias voltage to turn on or turn off M₂.

The other switch module 122 comprises a parallel structure composed of Q switch units 124. Each of the Q switch units 124 comprises a series unit of a MOSFET component M₁ and a resistor R₁ wherein a drain of each M₁ is coupled to one terminal of the resistor R₁, and the other terminal of the resistor R₁ is coupled to the cathode of the fuel cell 11, and a source of each M₁ is coupled to the anode of the fuel cell 11, and the switch control module 121 is coupled to gate (control terminals) of each M₁, thereby providing a bias voltage to turn on or off M₁.

In the present embodiment, P and Q are both positive integers, and P and Q are not 1 simultaneously (It becomes the fuel cell system of Embodiment 1, when P and Q are simultaneously 1). Those skilled in the art can understand that P and Q can be equal or not equal numbers, and similar technical effects can be obtained. Those are equivalent technical features, and all fall within the protection scope of the present invention.

The switch module comprises more than one switch unit. After the switch module is turned on, a plurality of current branches can be formed for shunting, thereby further reducing the load on the switches and providing good protection for the switches.

FIG. 6 is only a preferred embodiment. The switch is not limited to the illustrated MOSFET component in the embodiment. As described above, IBGT components, as well as other components and circuits for turning on and off circuits, can be used as switches in the embodiment.

As a preferred embodiment, in the fuel cell system of the present embodiment, the switch unit comprises a magnetic ring and a diode, wherein the magnetic ring is sleeved outside a wire of the switch unit, and the wire is a wire between the current input terminal and the cathode of the fuel cell, or the wire is a wire between the current output terminal and the anode of the fuel cell; and the diode is coupled in parallel with the magnetic ring.

Specifically, as shown in FIG. 6, the switch unit 124 further comprises a first magnetic ring MR₁, wherein the first magnetic ring MR₁ is sleeved outside the wire between R₁ and the cathode of the fuel cell 11 (Obviously, the first magnetic ring MR₁ can also be sleeved outside the wire between R₁ and the drain of M₁. In addition, when R₁ is coupled in series between the source of M₁ and the anode of the fuel cell 11, the first magnetic ring MR₁ is sleeved outside the wire between source of M₁ and the anode of the fuel cell 11). The switch unit 123 further comprises a second magnetic ring MR₂, wherein the second magnetic ring MR₂ is sleeved outside the wire between the drain of the M₁ and the cathode of the fuel cell 11.

Further, in the fuel cell system of the present embodiment, the switch unit 124 further comprises a first diode D₁, wherein the first diode D₁ and the first magnetic Ring MR₁ are coupled in parallel. Those skilled in the art can understand that the term “the first diode D₁ and the first magnetic Ring MR₁ are coupled in parallel” in the present invention is not limited to a direct parallel in which the first diode D₁ is directly coupled in parallel with the first magnetic ring MR₁, but also refers to a parallel in which one branch where the first diode D₁ is located is coupled in parallel to another branch where the first magnetic ring MR₁ is located. As shown in FIG. 6, a positive electrode of the first diode D₁ is coupled to the drain of M₁, and a negative electrode of the first diode D₁ is coupled to the cathode of the fuel cell 11. The first diode D₁ may also be coupled to the drain of M₁ or the anode of the fuel cell 11 via a component such as a resistor, that is, the branch formed by the first diode D₁ and the resistor coupled in series is coupled in parallel with another branch formed by the first magnetic ring MR₁ and the resistor R₁ coupled in series.

The switch unit 123 further comprises a second diode D₂, wherein the second diode D₂ is coupled in parallel with the second magnetic ring MR₂. Specifically, as shown in FIG. 6, a positive electrode of the second diode D₂ is coupled to the drain of the M₂, and a negative electrode of the second diode D₂ is coupled to the cathode of the fuel cell 11.

The fuel cell system of the present embodiment is a preferred embodiment. Although in the fuel cell system of the present embodiment, as shown in FIG. 6, only the case of two switch modules 122 is shown, those skilled in the art can understand that the fuel cell system of the present embodiment can comprise more switch modules 122 when Embodiment 3 is combined.

The embodiment further provides a fuel cell system control method, and the fuel cell system control method of the present embodiment is implemented by the fuel cell system of the present embodiment. The control method of the fuel cell system of this embodiment has similar steps to those of the control method of the fuel cell system in the above embodiments.

Specifically, in S101, the switch control module 121 simultaneously turns on the M₁s in number of Q which form shunting effect via Q branches, so that the current of M₁ on each branch is reduced. At the same time, as the voltage division protection of R₁ is combined, the protection effect on M₁ can be more improved and reliable. Then, the switch control module 121 simultaneously turns on the M₂s in number of P, and the functions and effects thereof are not redundantly described again.

Those skilled in the art can understand that in S101, the effect of the technical solution in which the switch control module 121 sequentially turns on the Q M₁s is weaker than the effect of the technical solution in which the switch control module 121 simultaneously turns on the Q M₁s. However, the approximate results still can be achieved. Therefore, the technical solution in which the switch control module 121 sequentially turns on the Q M₁s and the technical solution in which the switch control module 121 simultaneously turns on the Q M₁s should be regarded as equivalent, and all fall within the protection scope of the present invention.

Although the switch control module 121 simultaneously turns on Q M₁s, that is, the switch control module 121 simultaneously provides a suitable bias voltage to the gates of the Q M₁s to simultaneously turn on the Q M₁s, in reality, Q M₁s do not achieve the ideal “simultaneously” turned on, and there is a slight time difference. However, the current will concentrate on the branch that is turned on first due to the characteristics of the charge motion, so that the branch is subjected to a large current, and shunting effect of the Q switch units 124 in parallel is weakened. Therefore, the fuel cell system of the present embodiment further comprises magnetic rings (the first magnetic ring MR₁, the second magnetic ring MR₂). The function of the magnetic rings is dynamic current sharing. For example, when the switch control module 121 simultaneously turns on the Q M₁s, the current of the Q branches can be evenly distributed due to the dynamic current sharing function of the first magnetic ring MR₁, and is not focused on the branch that is turned on first, thus helping to protect M₁.

Preferably, the fuel cell system of the present embodiment further comprises two diodes (a first diode D₁, a second diode D₂), which are usually called as “freewheeling diodes”. The freewheeling diodes are often used with energy storage components (such as the magnetic ring in this embodiment) to prevent voltage and current jump and provide access. The inductor (such as the magnetic ring in this embodiment) can provide a continuous current to the load via the freewheeling diode to avoid load current jump and to smooth current. In the switch power supply, a freewheeling circuit composed of a diode and a first resistor coupled in series can be obtained and coupled in parallel with the primary side of the transformer (in this embodiment, the branch in which the freewheeling diode is located is coupled in parallel with another branch in which the magnetic ring is located). When the switch is turned off, the freewheeling circuit can release the energy stored in the transformer coil to prevent the induced voltage from being too high and breaking through the switch transistor. Generally, a fast recovery diode or a Schottky diode is selected, and used to consume the reverse potential generated by the coil in the form of a current, the function of the diode in the circuit is called “freewheeling”. Specifically, in this embodiment, when M₁ is turned off, freewheeling circuit formed by the first diode D₁ and the resistor R₁ is configured to release the energy stored in the first magnetic ring MR₁ to prevent the M₁ from being broken down.

In the fuel cell system control method of this embodiment, in S102, the switch control module 121 simultaneously turns off the Q M₁s. Alternatively, the switch control module 121 sequentially turns off the Q M₁s, and an approximate effect can be obtained. (The former is preferred.)

The operation of the switch module comprising the P switch units 123 will not be redundantly described herein.

### Embodiment 5

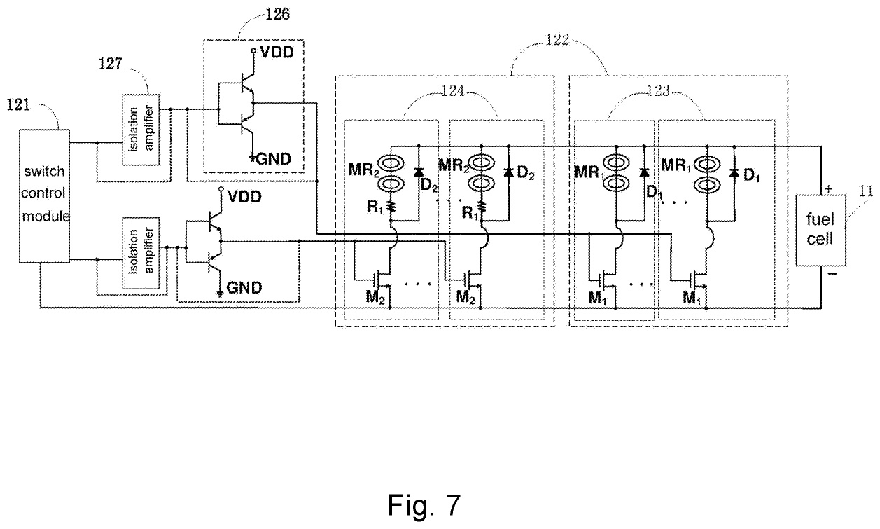

The fuel cell system of the present embodiment is substantially the same as the fuel cell system of Embodiment 4, except that the fuel cell system of the present embodiment further comprises the emitter followers in the same number as that of the switch modules, wherein the switch control module is respectively coupled to the control terminal of the switch in the corresponding switch modules via an emitter follower. Specifically, as shown in FIG. 7, the switch control module 121 is coupled to the gate of the M₁ via the emitter follower 126, and the switch control module 121 is coupled to the gate of M₂ via the emitter follower. Since the gate capacitance of the parallel structure of a plurality of MOSFETs is large, the emitter follower 126 can effectively ensure the speed of turning on and off M₁ and M₂ to reduce the loss caused by turning on and off M₁ and M₂. FIG. 7 only shows a preferred embodiment. In addition to the emitter follower 126 composed of a pair of transistors of NPN/PNP shown in FIG. 7, there are various other structures of the emitter follower.

There is also a problem that the gate capacitance of the parallel structure of a plurality of IGBTs is large. Therefore, the emitter follower in this embodiment is also applicable to the fuel cell systems of Embodiment 1, Embodiment 2, and Embodiment 3.

### Embodiment 6

The difference between the fuel cell system of the present embodiment and the fuel cell system of Embodiment 4 is that the fuel cell system of the present embodiment further comprises isolation amplifiers in the same number as that of the switch modules, wherein the switch control module is respectively coupled to the control terminal of the switch in the corresponding switch module via an isolation amplifier. Specifically, as shown in FIG. 7, the switch control module 121 is coupled to the gate of the M₁ via the isolation amplifier 127; the switch control module 121 is coupled to the gate of the M₂ via the isolation amplifier.

Similarly, the isolation amplifier in this embodiment is also applicable to the fuel cell systems of Embodiment 1, Embodiment 2, and Embodiment 3. The details will not be redundantly described again.

### Embodiment 7

The difference between the fuel cell system of the present embodiment and the fuel cell system of Embodiment 4 is that the fuel cell system of the present embodiment further comprises isolation amplifiers in the same number as that of the switch modules and emitter followers in the same number as that of the switch modules. The switch control module is respectively coupled to the control terminal of the switch in the corresponding switch module sequentially via an isolation amplifier and an emitter follower. Specifically, as shown in FIG. 7, the switch control module 121 is coupled to the gate of the M₁ sequentially via the isolation amplifier 127 and the emitter follower 126; the switch control module 121 is coupled to the gate of the M₂ sequentially via the isolation amplifier and the emitter follower.

Similarly, the isolation amplifier and the emitter follower in this embodiment are also applicable to the fuel cell systems of Embodiment 1, Embodiment 2, and Embodiment 3. The details will not be redundantly described again.

While the invention has been described with respect to the preferred embodiments of the present invention, it should be understood that the scope of the invention is defined by the appending claims. Those skilled in the art can make various changes or modifications to the embodiments without departing from the spirit and scope of the invention, and such changes and modifications fall within the scope of the invention.

1. A fuel cell system, which comprises: a fuel cell, a switch control module and at least two switch modules;
wherein each of the at least two switch modules comprises a switch unit which comprises a switch, and the switch comprises a control terminal, a current input terminal and a current output terminal;
in the at least two switch modules, the switch unit in at least one switch module further comprises a voltage division structure which is coupled in series between the current input terminal and a cathode of the fuel cell, or is coupled in series between the current output terminal and an anode of the fuel cell;
in the remaining switch modules of the at least two switch modules, the current input terminal is coupled to the cathode of the fuel cell, and the current output terminal is coupled to the anode of the fuel cell; and
the switch control module is respectively coupled to the control terminals of the switches of the at least two switch modules for respectively controlling the switches to be turned on or off.

2. The fuel cell system of claim 1, wherein the switch comprises a MOSFET, and the control terminal is a gate of the MOSFET, the current input terminal is a drain of the MOSFET, and the current output terminal is a source of the MOSFET;
or,
the switch comprises an IGBT, and the control terminal is a gate of the IGBT, the current input terminal is a collector of the IGBT, and the current output terminal is an emitter of the IGBT.

3. The fuel cell system of claim 1, wherein the voltage division structure comprises a resistor.

4. The fuel cell system of claim 3, wherein in the at least two switch modules, the resistance values of the resistors comprised in the switch units of the different switch modules are different.

5. The fuel cell system of claim 4, wherein the fuel cell system comprises three switch modules; and two switch modules among the three switch modules comprise the resistor.

6. The fuel cell system of claim 1, wherein at least one switch module of the at least two switch modules comprise at least two switch units which are coupled in parallel.

7. The fuel cell system of claim 6, wherein each of the at least two switch units comprises a magnetic ring and a diode, wherein the magnetic ring is sleeved outside a wire of the switch unit; and the wire is a wire between the current input terminal and the cathode of the fuel cell, or the wire is a wire between the current output terminal and the anode of the fuel cell; and the diode is coupled in parallel with the magnetic ring.

8. The fuel cell system of claim 1, wherein the fuel cell system further comprises emitter followers in the same quantity as that of the switch module, wherein the switch control module is respectively coupled to the control terminal of the switch in a corresponding switch module via an emitter follower;
or the fuel cell system further comprises isolation amplifiers in the same quantity as that of the switch modules, wherein the switch control module is respectively coupled to the control terminal of the switch in a corresponding switch module via an isolation amplifier;
or the fuel cell system further comprises isolation amplifiers in the same quantity as that of the switch modules and emitter followers in the same quantity as that of switch modules, wherein the switch control module is respectively coupled to the control terminal of the switch in a corresponding switch module via an isolation amplifier and an emitter follower.

9. A fuel cell system control method, which is implemented by using the fuel cell system according to claim 1, wherein the method comprises the steps of:
S1, turning on the switches of the at least two switch modules by the switch control modules sequentially; and
S2, turning off the switches of the at least two switch modules by the switch control module after waiting for a first preset time.

10. The fuel cell system control method of claim 9, wherein in S1, turning on the switches of the at least two switch modules by the switch control modules sequentially is according to a preset time interval.

11. The fuel cell system control method of claim 9, wherein in the fuel cell system control method, step S2 is replaced with step S3:
S3, turning off the switches of the at least two switch modules by the switch control module after waiting for a second preset time.

12. The fuel cell system control method of claim 9, wherein the voltage division structure comprises a resistor, and the resistance values of the resistors comprised in the switch units of the different switch modules are different; and
S1 comprises: turning on the switches coupled in series with the resistors by the switch control module according to the resistance values of the resistors in descending order.

13. The fuel cell system control method of claim 11, wherein the voltage division structure comprises a resistor, and the resistance values of the resistors comprised in the switch units of the different switch modules are different; and
S3 comprises: turning on the switches coupled in series with the resistors by the switch control module according to the resistance values of the resistors in descending order after waiting for a second preset time.
